(19) United States
(12) Patent Application Publication
(10) Pub. No.: US 2014/0201598 A1
(43) Pub. Date: Jul. 17, 2014

(54) SOLID STATE DRIVE AND DATA RETENTION METHOD THEREOF

(71) Applicant: LITE-ON IT CORPORATION, Taipei (TW)

(72) Inventor: Kun Chang Chang, Hsinchu (TW)

(21) Appl. No.: 13/916,700

(22) Filed: Jun. 13, 2013

(30) Foreign Application Priority Data
Jan. 16, 2013 (CN) 201310015322.9

(51) Int. Cl. G06F 11/16

(52) U.S. Cl. CPC G06F 11/1612
USPC 714/766; 714/773

(57) ABSTRACT

A data retention method is provided. After the solid state drive is powered on, a current date information is received from a host. If a control command is generated by the host and the control command is a write command, the control command is executed, so that a new data is written into a flash memory. If no control command is generated, a first stored data is read out from the flash memory. Then, a stored date information of the first stored data is compared with the current date information, thereby acquiring a calculated time period. If the calculated time period is larger than a predetermined time period, the first stored data is updated by changing the stored date information to the current date information, and the updated first stored data is written into another location of the flash memory.

This application claims the benefit of People's Republic of China Application Ser. No. 201310015322.9, filed Jan. 16, 2013, the subject matter of which is incorporated herein by reference.

### FIELD OF THE INVENTION

The present invention relates to a data storage device and a data retention method thereof, and more particularly to a solid state drive and a data retention method thereof.

### BACKGROUND OF THE INVENTION

As is well known, a solid state drive (SSD) is a data storage device that uses a non-volatile memory to store data. After data are written to the non-volatile memory, if the system is powered off, the data are still retained in the solid state drive. For example, the non-volatile memory is a flash memory.

FIG. 1 is a schematic functional block diagram illustrating an electronic device with a solid state drive. As shown in FIG. 1, the electronic device 50 comprises a host 12 and a solid state drive 10. The solid state drive 10 comprises a controlling unit 101 and a flash memory 105. The controlling unit 101 is in communication with the host 12 through an external bus 20. Consequently, commands and data can be exchanged between the controlling unit 101 and the host 12. Generally, the external bus 20 is a USB bus, an IEEE 1394 bus, a SATA bus, or the like.

Moreover, the host 12 may issue a control command to the controlling unit 101 of the solid state drive 10. According to the control command, the data are read out from or written into the flash memory 105.

The electronic device 50 is for example a computer system, a digital camera system or a digital playback system.

For example, when the host 12 issues a write command and a write address to the controlling unit 101, a user data is transmitted from the host 12 to the controlling unit 101. In addition, an error correction code (ECC code) is correspondingly generated by an error correction unit (ECC unit, not shown) of the controlling unit 101. The user data and the ECC code are written into the flash memory 105 together. On the other hand, when the host 12 issues a read command and a read address to the controlling unit 101, the corresponding user data and the ECC code are read out from the flash memory 105 by the controlling unit 101. After the error is corrected by the error correction unit, the user data can be accurately transmitted from the controlling unit 101 to the host 12.

Nowadays, with increasing development of the fabricating process of the non-volatile memory (e.g. the flash memory), the unit price of the non-volatile memory is reduced, and thus the applications of the non-volatile memory is increased. However, when the non-volatile memory is exposed to a high-temperature condition, the accuracy of the data stored in the non-volatile memory will be impaired.

Generally, if the data stored in the non-volatile memory have not been refreshed for a long time, the stored data are at the risk of being lost. The risk continuously exists when the solid state drive is in the normal working state or the solid state drive is powered off.

### SUMMARY OF THE INVENTION

An embodiment of the present invention provides a data retention method for a solid state drive. The solid state drive is in communication with a host. The data retention method includes the following steps. After the solid state drive is powered on, a current date information is received from the host. If a control command is generated by the host and the control command is a write command, the control command is executed, so that a new data is written into a flash memory of the solid state drive. The new data contains a user data, an ECC code and the current date information, and the current date information is a stored date information of the new data. If no control command is generated by the host, a first stored data of plural stored data is read out from the flash memory. Then, a stored date information of the first stored data is compared with the current date information, thereby acquiring a calculated time period. If the calculated time period is larger than a predetermined time period, the first stored data is updated by changing the stored date information to the current date information, and the updated first stored data is written into another location of the flash memory.

Another embodiment of the present invention provides a solid state drive in communication with a host. The solid state drive includes a flash memory and a controlling unit. The controlling unit is connected between the host and the flash memory. After the controlling unit is powered on, a current date information from the host is received by the controlling unit. If a control command is generated by the host and the control command is a write command, the control command is executed by the controlling unit, so that a new data is written into the flash memory. The new data contains a user data, an ECC code and the current date information, and the current date information is a stored date information of the new data. If no control command is generated by the host, the controlling unit reads out a first stored data of plural stored data from the flash memory, and compares a stored date information of the first stored data with the current date information, thereby acquiring a calculated time period. If the calculated time period is larger than a predetermined time period, the controlling unit updates the first stored data by changing the stored date information to the current date information, and writes the updated first stored data into another location of the flash memory.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating an electronic device with a solid state drive;

FIG. 2 schematically illustrates the relationship between the data recovery probability of a flash memory and the data storing time;

FIG. 3 is a schematic functional block diagram illustrating an electronic device with a solid state drive according to an embodiment of the present invention;

FIG. 4 schematically illustrates the layout of an 8K-byte page; and

FIG. 5 is a flowchart illustrating a data retention method for a solid state drive according to an embodiment of the present invention.

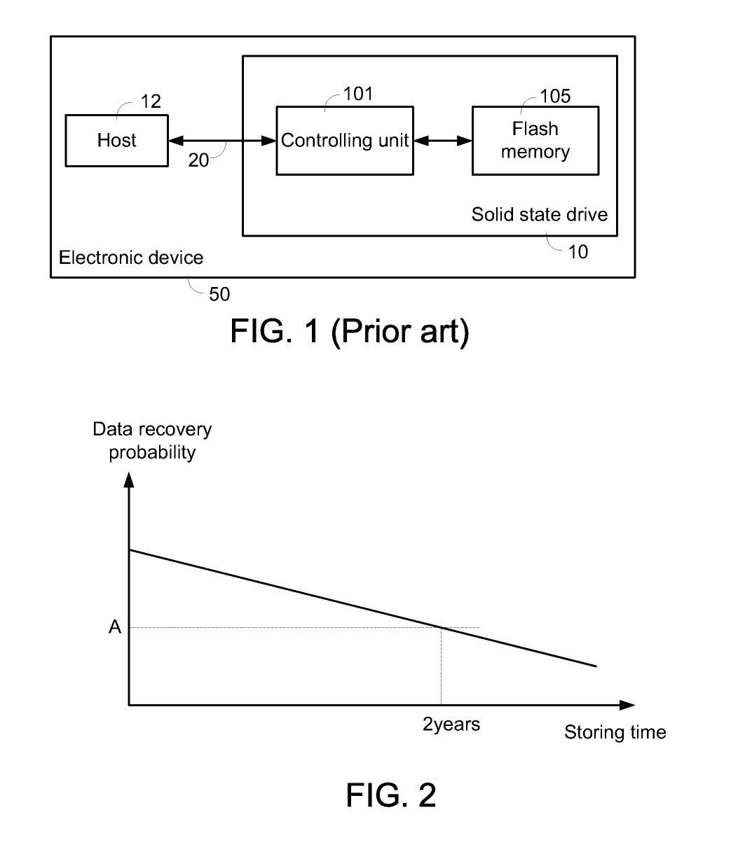

### DETAILED DESCRIPTION OF PREFERRED EMBODIMENTS

FIG. 2 schematically illustrates the relationship between the data recovery probability of a flash memory and the data storing time. For example, after the data has been stored in the flash memory for a certain time period (e.g. 2 years) without any further process, the data recovery probability is reduced to be lower than a specified value A (e.g. 95%). In other words, after the data have been stored in the flash memory for more than 2 years without any further process, the stored data may fail to be effectively read out from the flash memory. For solving this problem, the present invention provides a solid state drive and a data retention method for the solid state drive.

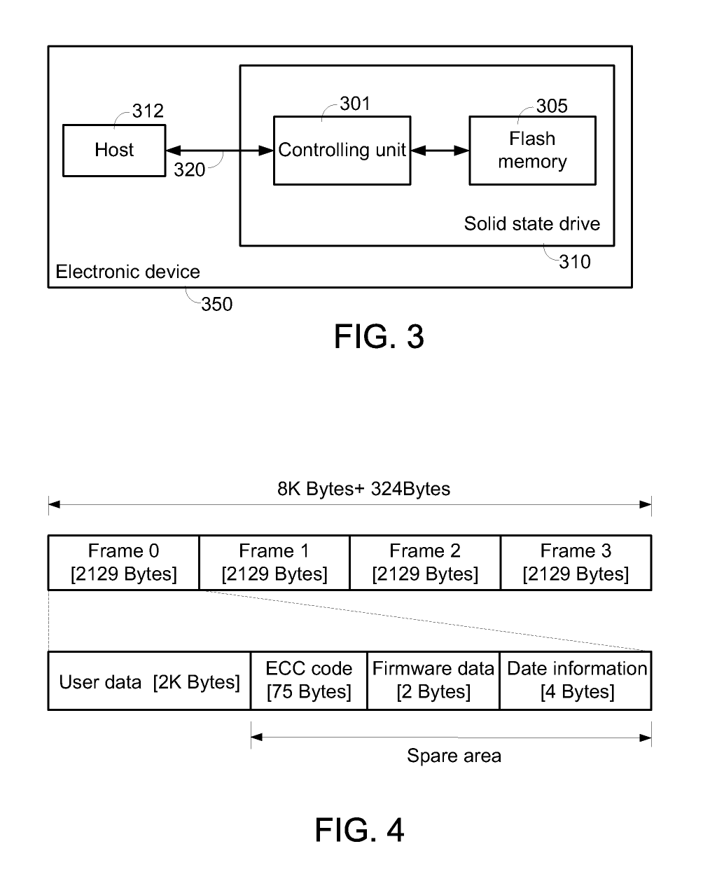

FIG. 3 is a schematic functional block diagram illustrating an electronic device with a solid state drive according to an embodiment of the present invention. As shown in FIG. 3, the electronic device 350 comprises a host 312 and a solid state drive 310. The solid state drive 310 comprises a controlling unit 301 and a flash memory 305. The controlling unit 301 is in communication with the host 312 through an external bus 320. Consequently, commands and data can be exchanged between the controlling unit 301 and the host 312. Generally, the external bus 320 is a USB bus, an IEEE 1394 bus, a SATA bus, or the like.

In accordance with a feature of the present invention, the operating mechanism of the controlling unit 301 is specially designed. When a user data is transmitted from the host 312 to the solid state drive 310, the date information is correspondingly stored into the flash memory 305 by the controlling unit 301. According to the date information, the controlling unit 301 may determine whether the subsequent data needs to be subjected to a data retention operation or not. The concepts of the present invention will be illustrated in more details as follows.

Generally, the flash memory 305 comprises plural blocks. Each block comprises plural pages, for example 64 pages. Each page is typically 8K bytes in size. Due to the inherent properties of the flash memory 305, at least one page is written at a time during the writing operation is performed, and the erasing operation is performed in a block-wise fashion.

FIG. 4 schematically illustrates the layout of an 8K-byte page. In practice, the data layout of the 8K-byte page comprises 8K bytes data area and 324 bytes spare area. The 8K-byte page may be divided into four frames (Frame 0-Frame 3). Each frame has 2129 bytes.

For example, the 2129 bytes of the zero-frame (Frame 0) are allocated into a 2K bytes user data area and an 81 bytes spare area. The 81 bytes of the spare area may be defined by the manufacturer of the solid state drive 310. For example, the 81 bytes of the spare area are allocated into a 75 bytes ECC code, a 2 bytes firmware data and a 4 bytes stored date information. That is, when one page data are written into the flash memory 305 by the controlling unit 301, the stored data at least comprises the user data, the ECC code and the stored date information. Moreover, the ECC code and the stored date information are recorded into the spare area.

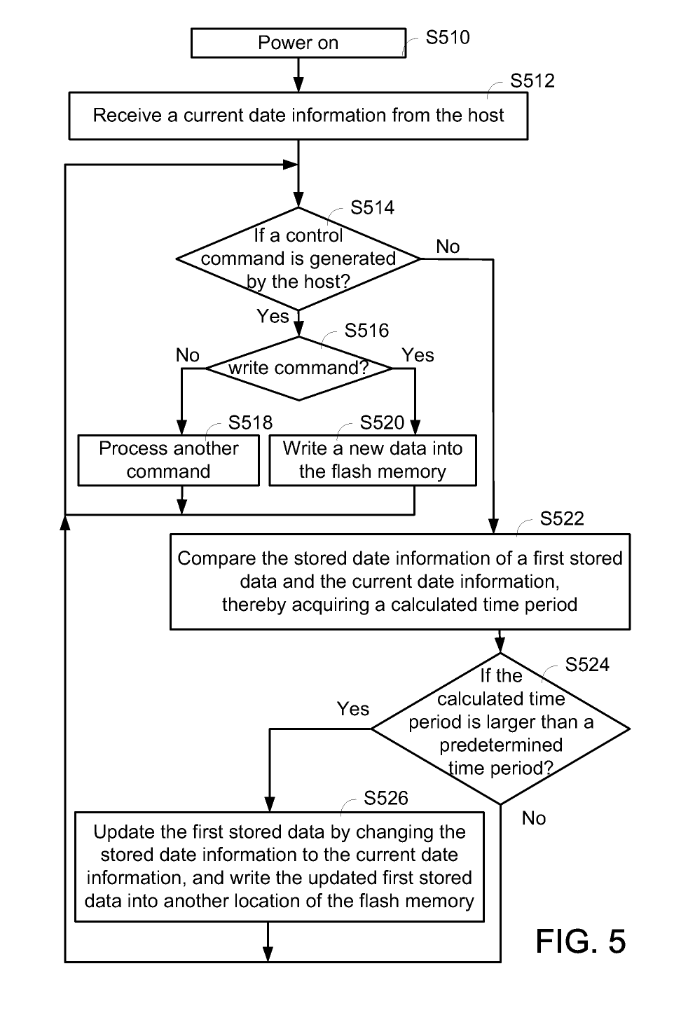

FIG. 5 is a flowchart illustrating a data retention method for a solid state drive according to an embodiment of the present invention. After the solid state drive is powered on (Step S510), a current date information from the host is received (Step S512).

Then, the step S514 is performed to judge whether a control command is generated by the host. If the control command is generated by the host (Step S514), the control command is executed. Then, a step S516 is performed to judge whether the control command is a write command. If the control command is the write command in the step S516, a new data is written into the flash memory by the controlling unit (Step S520). The new data contains the user data, the ECC code and the current date information. The ECC code and the current date information are recorded into the spare area. After the new data is written into the flash memory, the current date information of the new data denotes the stored date information of this new data. If the control command is not the write command in the step S516, the control command (i.e. another command different from the write command) is processed by the controlling unit (Step S518).

If no control command is generated by the host (Step S514), the solid state drive is in an idle state. Meanwhile, a first stored data of plural stored data is read out from the flash memory by the controlling unit, and a procedure of judging the risk of losing the first stored data is started.

For performing the procedure of judging the risk of losing the first stored data, the stored date information of the first stored data is read out and compared with the current date information, and thus a calculated time period is acquired (Step S522). The calculated time period is the time period between the current date and the stored date. Then, a step S524 is performed to judge whether the calculated time period is larger than a predetermined time period. If the calculated time period is larger than a predetermined time period (Step S524), the first stored data is updated by changing the stored date information to the current date information, and the updated first stored data is written into another location of the flash memory (Step S526). Under this circumstance, the stored date information of the updated first stored data is changed to be identical to the current date information. On the other hand, if the calculated time period is not larger than the predetermined time period in the step S524, the first stored data is maintained unchanged.

After the updated first stored data is stored, if no control command is generated by the host (Step S514), the stored date information of a second stored data and the current date information are compared with each other, and thus a calculated time period is obtained (Step S522). Then, the step S524 is performed to judge whether the calculated time period is larger than the predetermined time period. If the calculated time period is larger than the predetermined time period (Step S524), the step S526 is performed. The above steps S514, S522, S524 and S526 are repeatedly performed until another control command is generated by the host or the solid state drive is powered off.

In this embodiment, each stored data of the plural stored data denotes the data of one page. The ECC code and the stored date information are recorded into the spare area of one page. Alternatively, in some other embodiments, each stored data of the plural stored data denotes the data of one block. The ECC code and the stored date information are recorded into the spare area of one block.

Under the condition that each stored data of the plural stored data denotes the data of one page. When the solid state drive is powered on, the current date information from the host is immediately received. Then, when the write command is executed by the solid state drive, the user data is written into a new page. The new page at least comprises the user data, the ECC code and the current date information as the stored date information.

When the solid state drive is in the idle state, the procedure of judging the risk of losing the first stored data is started, and a remedy measure is taken. In this embodiment, a stored date information of the stored data of one page is read out and compared with the current date information, so that a calculated time period is obtained. If the calculated time period is larger than the predetermined time period (e.g. 1.5 year), it means that the data of this page is possibly lost. For preventing the data from being lost, the stored data of this page is firstly updated by changing the stored date information to the current date information, and then the updated stored data of this page (including the user data, the ECC code and the current date information) is written into another location of the flash memory. At the same time, the location of the old page is set as an invalid page, and fails to be read again.

From the above discussions, when the solid state drive is in the idle state, the stored data can be read out. Moreover, according to the stored date information of the stored data and the current date information, the controlling unit can realize whether there is a risk of losing the stored data. If there is a risk of losing the stored data, a remedy measure is taken. Consequently, the data retention method is capable of increasing the retention time of the stored data and reducing the risk of losing the stored data.

It is noted that many ways may be performed to acquire the current date information. For example, after the solid state drive is powered on, the controlling unit issuing a date-reading command to the host. In response to the date-reading command, the current date information is transmitted from the host to the solid state drive. Alternatively, after the solid state drive is powered on, the current date information is transmitted from the host to the solid state drive automatically.

From the above descriptions, the present invention provides a solid state drive and a data retention method for the solid state drive. When the user data is written into the flash memory of the solid state drive, the user data, the ECC code and the current date information are combined as a new data to be written into the flash memory. The current date information of the new data indicates the stored date information when the new data is written into the flash memory. The user data is written into the flash memory according to the write command or a garbage collection, etc. That means every time the user data is written to the flash memory, the stored date information would be the current date information.

When the solid state drive is in the idle state, a stored date information of a stored data compared with the current date information. According to the comparing result, the procedure of judging the risk of losing the stored data is started, and a remedy measure is taken.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures

What is claimed is:

1. A data retention method for a solid state drive, the solid state drive being in communication with a host, the data retention method comprising steps of:
receiving a current date information from the host after the solid state drive is powered on;
if a control command is generated by the host and the control command is a write command, executing the control command, so that a new data is written into a flash memory of the solid state drive, wherein the new data contains a user data, an ECC code and the current date information, and the current date information is a stored date information of the new data;
if no control command is generated by the host, reading out a first stored data of plural stored data from the flash memory;
comparing a stored date information of the first stored data with the current date information, thereby acquiring a calculated time period; and
if the calculated time period is larger than a predetermined time period, updating the first stored data by changing the stored date information to the current date information, and writing the updated first stored data into another location of the flash memory.

2. The data retention method as claimed in claim 1, wherein the ECC code and the stored date information are recorded into a spare area of the flash memory.

3. The data retention method as claimed in claim 1, wherein each stored data of the plural stored data is a data of one page or a data of one block.

4. The data retention method as claimed in claim 1, wherein after the solid state drive is powered on, the solid state drive issues a date-reading command to the host, wherein in response to the date-reading command, the host transmits the current date information to the solid state drive, so that the current date information is received from the host.

5. The data retention method as claimed in claim 1, wherein after the solid state drive is powered on, the host transmits the current date information to the solid state drive automatically, so that the current date information is received from the host.

6. A solid state drive in communication with a host, the solid state drive comprising:
a flash memory; and
a controlling unit connected between the host and the flash memory, wherein after the controlling unit is powered on, a current date information from the host is received by the controlling unit,
wherein if a control command is generated by the host and the control command is a write command, the control command is executed by the controlling unit, so that a new data is written into the flash memory, wherein the new data contains a user data, an ECC code and the current date information, and the current date information is a stored date information of the new data;
wherein if no control command is generated by the host, the controlling unit reads out a first stored data of plural stored data from the flash memory, and compares a stored date information of the first stored data with the current date information, thereby acquiring a calculated time period,
wherein if the calculated time period is larger than a predetermined time period, the controlling unit updates the first stored data by changing the stored date information to the current date information, and writes the updated first stored data into another location of the flash memory.

7. The solid state drive as claimed in claim 6, wherein the ECC code and the stored date information are recorded into a spare area of the flash memory.

8. The solid state drive as claimed in claim 6, wherein each stored data of the plural stored data is a data of one page or a data of one block.

9. The solid state drive as claimed in claim 6, wherein after the controlling unit is powered on, the solid state drive issues a date-reading command to the host, wherein in response to the date-reading command, the host transmits the current date information to the solid state drive.

10. The solid state drive as claimed in claim 6, wherein after the controlling unit is powered on, the host transmits the current date information to the solid state drive automatically.
